(19) United States
(12) Patent Application Publication
(10) Pub. No.: US 2023/0122472 A1
(43) Pub. Date: Apr. 20, 2023

(54) Hybrid Techniques for Quality Estimation of a Decision-Making Policy in a Computer System

(71) Applicant: International Business Machines Corporation, Armonk, NY (US)

(72) Inventors: Benjamin Tyler Elder, White Plains, NY (US); Matthew Richard Arnold, Ridgefield Park, NJ (US); Michael Lawrence Stickler, Columbus, OH (US)

(21) Appl. No.: 17/504,266

(22) Filed: Oct. 18, 2021

(51) Int. Cl. G06Q 30/02; G06N 5/02

(52) U.S. Cl. CPC G06Q 30/0224; G06N 5/02

(57) ABSTRACT

Hybrid on-policy/off-policy techniques are provided for improving the estimation of quality (reward) of a control policy for decision making by combining the on-policy and off-policy data from multiple estimators into a single metric. In one aspect, a method for estimating a reward of a policy for decision making in a computer system includes: computing multiple reward estimates of the policy using estimators, wherein at least a subset of the estimators compute reward estimates with prediction intervals; and combining the multiple reward estimates using a combiner to produce a new reward estimate. Thus, some of the estimators might compute the reward estimates without prediction intervals. A method for estimating a reward of a policy when another one or more of the estimators compute reward estimates without prediction intervals is also provided.

### FIELD OF THE INVENTION

The present invention relates to the evaluation of decision-making policies in a computer system, and more particularly, to hybrid on-policy/off-policy techniques for improving the estimation of quality (reward) of a control policy for decision making in a computer system by combining the on-policy and off-policy data from multiple estimators into a single metric, accounting for the variance of each component.

### BACKGROUND OF THE INVENTION

A control policy (or simply ‘a policy’) is an algorithm or system that interacts with an environment by choosing different actions. The environment then produces reward feedback for those actions. For example, in a chatbot application the environment might include a message from a user, and the control policy chooses a response to this user message. Whether the user likes the response can be used as the reward.

A key challenge when publishing and maintaining software such as a control policy is evaluating the quality (often referred to as the ‘reward’) of new versions of the software before they are released and/or made available to all users. For instance, evaluation prior to release of the new policy to any users, i.e., pre-deployment (or ‘pre-deploy’) evaluation, can be performed using testing, test sets or manual evaluation. However, these approaches are time consuming and often produce unreliable results. While more advanced approaches for pre-deploy evaluation are available such as counterfactual estimation (also called counterfactual evaluation), this technique often has high variance/low confidence (i.e., it has the potential to produce poor estimates) when used on a small number of data points.

Routing a small subset of log traffic to the new policy enables evaluation using on-policy approaches such as A-B testing which leverage real log data (including reward from the environment) for the policy being evaluated. However, while this technique is an effective approach for quality estimation and works well regardless of the divergence between policies, it can also require a significant amount of data to produce a low variance (high confidence) estimate.

Therefore, techniques for providing a higher quality estimation of the reward for a new policy that accounts for the variance of conventional estimators would be desirable.

### SUMMARY OF THE INVENTION

The present invention provides hybrid on-policy/off-policy techniques for improving the estimation of quality (reward) of a control policy for decision making by combining the on-policy and off-policy data from multiple estimators into a single metric. In one aspect of the invention, a computer-based method for estimating a reward of a policy for decision making in a computer system is provided. The method includes: computing multiple reward estimates of the policy using estimators, wherein at least a subset of the estimators compute reward estimates with prediction intervals; and combining the multiple reward estimates using a combiner to produce a new reward estimate. Thus, some of the estimators might compute the reward estimates without prediction intervals. Advantageously, the new reward estimate can have a lower variance than any of the multiple reward estimates alone.

In one exemplary embodiment, at least one of the estimators is an off-policy estimator (such as counterfactual estimation), and at least another one of the estimators is an on-policy estimator (such as A-B testing). A variety of statistical and/or heuristic techniques can be employed by the combiner to combine the multiple reward estimates such as, but not limited to, mean (average), median, enveloping, quartiles, asymmetrical and symmetrical trimmed mean, unweighted average, median judgement, median absolute deviation, precision-weighted average, probability-weighted average, certainty-weighted average and/or entropy-weighted average.

In another aspect of the invention, another computer-based method for estimating a reward of a policy for decision making in a computer system is provided. The method includes: computing multiple reward estimates of the policy using estimators, wherein a subset of the estimators compute reward estimates with prediction intervals, and another one or more of the estimators compute reward estimates without prediction intervals; and combining the reward estimates with prediction intervals and the reward estimates without prediction intervals using a combiner to produce a new reward estimate.

For instance, the reward estimates with prediction intervals and the reward estimates without prediction intervals can be combined by combining the reward estimates with prediction intervals to produce an aggregate prediction interval; combining the reward estimates without prediction intervals to produce a point estimate; and combining the aggregate prediction interval and the point estimate to produce a new point estimate, wherein the new point estimate is used as the new reward estimate.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating how the advantages of counterfactual estimation and A-B testing can be leveraged for different scenarios according to an embodiment of the present invention;

FIG. 2 is a diagram illustrating use of a Combiner to combine reward estimates from multiple (e.g., off-policy/on-policy) Estimators to produce a new reward estimate according to an embodiment of the present invention;

FIG. 3 is a schematic diagram illustrating an exemplary neural network according to an embodiment of the present invention;

FIG. 4 is a diagram illustrating an exemplary methodology for estimating the reward of a policy for decision making in a computer system according to an embodiment of the present invention;

FIG. 5 is a diagram illustrating an exemplary methodology for aggregating reward estimates based on the mean (average), median and/or minimum/maximum upper and lower bounds of the estimates estimating according to an embodiment of the present invention;

FIG. 6 is a diagram illustrating an exemplary methodology for aggregating reward estimates using quartiles according to an embodiment of the present invention;

FIG. 7 is a diagram illustrating an exemplary methodology for aggregating reward estimates using an asymmetric trimmed mean approach according to an embodiment of the present invention;

FIG. 8 is a diagram illustrating an exemplary methodology for aggregating reward estimates using a symmetric trimmed mean approach according to an embodiment of the present invention;

FIG. 9 is a diagram illustrating an exemplary methodology for aggregating reward estimates using a median absolute deviation approach according to an embodiment of the present invention;

FIG. 10 is a diagram illustrating an exemplary methodology for aggregating reward estimates using a precision-weighted average approach according to an embodiment of the present invention;

FIG. 11 is a diagram illustrating an exemplary methodology for aggregating reward estimates using a probability-weighted average approach according to an embodiment of the present invention;

FIG. 12 is a diagram illustrating an exemplary methodology for aggregating reward estimates using a certainty-weighted average approach according to an embodiment of the present invention;

FIG. 13 is a diagram illustrating an exemplary methodology for aggregating reward estimates using an entropy-weighted average approach according to an embodiment of the present invention;

FIG. 14 is an exemplary methodology for estimating the reward of a policy when only a subset of the estimators includes prediction intervals with their estimates according to an embodiment of the present invention;

FIG. 15 is an exemplary methodology for combining an aggregate prediction interval and a point estimate to produce a new point estimate as the new reward estimate according to an embodiment of the present invention;

FIG. 16 is a diagram illustrating an exemplary apparatus for performing one or more of the methodologies presented herein according to an embodiment of the present invention;

FIG. 17 depicts a cloud computing environment according to an embodiment of the present invention; and

FIG. 18 depicts abstraction model layers according to an embodiment of the present invention.

### DETAILED DESCRIPTION OF PREFERRED EMBODIMENTS

Provided herein are hybrid on-policy/off-policy techniques for improving the estimation of quality (reward) of a control policy for decision making by combining the on-policy and off-policy data from multiple estimators into a single metric, accounting for the variance of each component. The present techniques are generally applicable to any software in a computer system that makes decisions, i.e., has a decision-making control policy. By way of example only, machine learning is one such non-limiting example of a computer system with which the present techniques can be implemented. For instance, reinforcement learning is an area of machine learning that employs decision-making policies. Namely, reinforcement learning algorithms are commonly expressed as policies. The goal of reinforcement learning is to learn a decision-making policy to guide the agent to make decisions. Similarly, a machine learning model that is trained offline, and then used online in a web site to make decisions is another example of a decision-making policy. The present hybrid on-policy/off-policy approach can be used to provide a high-quality reward estimation of these decision-making policies.

Evaluating the quality of a new policy is typically performed in multiple stages. The first stage is pre-deploy evaluation which, as highlighted above, occurs before the new policy is released to any users. Counterfactual evaluation (or also ‘counterfactual estimation’) is the task of using log data (i.e., a recording of the actions and rewards of one policy, or one set of policies) to estimate the expected reward of a different policy. This different policy would be a possible candidate to become the new default policy, i.e., to begin running in the dynamic system or software application previously operated by the original policy. Counterfactual estimation is also referred to herein as ‘off-policy evaluation’ or ‘off-policy estimation’ because log data does not exist for the new policy being evaluated since the new policy has not yet been deployed. While counterfactual/off-policy estimation has proven successful in multiple real-world deployments, it often has high variance/low confidence when used on a small number of data points.

Once a new policy has passed pre-deploy evaluation, the new policy is deployed into production and live traffic is routed to it, in a process called A-B testing. Typically, a gentle rollout of the new policy is performed whereby a small subset of log traffic is routed to the new policy while it is monitored to ensure that the new policy is performing as expected before more traffic is routed to it. This allows the service provider to roll back the new policy if anything goes wrong, while minimizing the number of users that are negatively impacted. A-B testing is often referred to as on-policy estimation since data is sent to the policy and real log data (including reward from the environment) is available for the policy being evaluated. However, as highlighted above, A-B testing can also require a significant amount of data to produce a low variance (high confidence) estimate.

Traditionally, these off-policy and on-policy methods such as counterfactual estimation and A-B testing, respectively are thought of as being independent, with counterfactual estimation being appropriate for pre-deploy evaluation, and A-B testing being used to do safe deployment. However, as described above, depending on the scenario there can be notable drawbacks associated with each approach when used independently.

For instance, one type of counterfactual estimator, Inverse-propensity scoring or IPS, utilizes the ratio of the probabilities for a given response from two separate policies. This ratio can be used to construct an estimate of the counterfactual performance of the policy which was not actually used for these queries. However, counterfactual estimators like IPS often produces high variance, low confidence reward estimates when used on a small number of data points. Since counterfactual estimation uses historical logs from prior policies to evaluate a new (not yet deployed) policy, the amount of variance is a function of how similar the new policy is to the prior policies. The more the new policy diverges from the prior policies, the more variance there is, and the more data points that are needed to produce a reliable reward estimate. Thus, in some scenarios (such as where divergence is high), hundreds of thousands, or even millions of data points can be required in order to produce a reliable reward estimate (i.e., an estimate with small error bars). In the extreme case (but in practice very common) where the new policy can choose options which were not available at all to the old policy, such as new answer choices for a chatbot to reply to a user, many counterfactual algorithms cannot estimate the reward that the new policy would receive even with unlimited amounts of historical data.

Techniques such as Doubly Robust, SWITCH, and CAB have been proposed to reduce the variance of counterfactual estimates. These methods rely on a combination of estimates from two different estimators, a ‘direct method’ estimator and a counterfactual estimator. The ‘direct method’ estimator utilizes a statistical/machine learning model which, given relevant input features, directly estimates the reward. These methods employing a direct method estimator as a second estimator tend to perform better than counterfactual estimation when the number of data points is small, but worse than counterfactual estimation when the number of data points is large. Thus, being able to use both approaches, and relying more on counterfactual estimation as the number of data points grows, is an effective approach.

As provided above, on-policy estimation such as A-B testing (a sampling technique) involves routing a small subset of log traffic to a new policy. Like counterfactual estimation, A-B testing can also require a significant number of data points to produce low variance, high confidence reward estimates. Thus, the amount of time it takes to produce a quality estimate with A-B testing is a function of how much log traffic is routed to the new policy. For example, if only 0.1% of log traffic goes to the new policy, then it can take a long time before there are enough examples to make a confident conclusion about its quality. Namely, to estimate the average performance according to a single number, i.e., the click rate of answers selected by a policy, to an accuracy of ~1% could take a few hundred data points. Thus, if one policy is receiving 0.1% of the traffic, then hundreds of thousands of data points in overall traffic would be required to provide an accurate answer. Furthermore, the other 99.9% of data points are not used for estimating the reward of the new policy, which is particularly wasteful especially if the two policies are similar (i.e., when divergence is low).

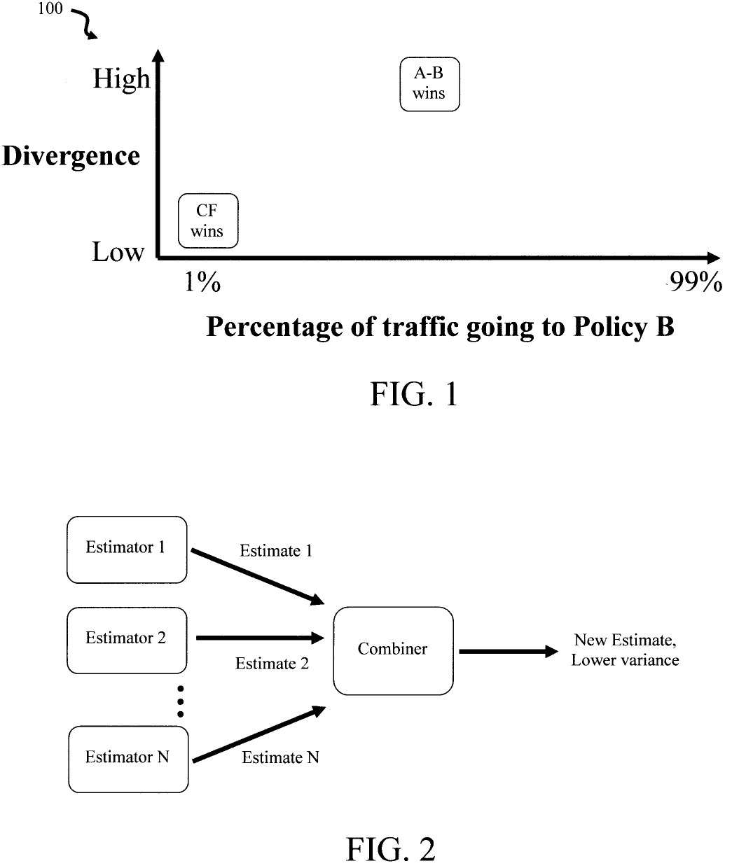

Thus, off-policy methods such as counterfactual estimation and on-policy methods such as A-B testing both have their advantages, and each tends to perform better than the other in certain scenarios. See, for example, graph 100 illustrated in FIG. 1. In the exemplary scenario depicted in FIG. 1, it is assumed that a log was created by executing a combination of policies A and B, where Policy A is the prior policy and Policy B is the new policy. In graph 100, divergence, i.e., how similar new Policy B is to the prior Policy A, is plotted on the y-axis. A low divergence indicates that the new Policy B is similar to the prior Policy A, whereas a high divergence indicates that the new Policy B is dissimilar to the prior Policy A. The percentage of log traffic being routed to the new Policy B is plotted on the x-axis.

As shown in graph 100, given a scenario where the divergence of the new Policy B from the prior Policy A is high, and a relatively large amount of log traffic (i.e., about 50%) is being routed to the new Policy B, then use of A-B testing has advantages over counterfactual estimation (see “AB Wins”). Namely, as described above, with counterfactual estimation variance is a function of model divergence. Thus, with highly divergent policies, counterfactual estimation confidence will be low. However, under those same conditions, since A-B testing is not impacted by divergence, and since there are plenty of data points for estimating the reward of the new policy with 50% of log traffic being routed to the new Policy B, then A-B testing is the clear winner for providing a high-quality estimate. Namely, A-B testing performs better when the policies are different (i.e., there is high divergence) but the amount of log traffic going to each policy is roughly equal (about 50%).

On the other hand, given a different scenario where the divergence of the new Policy B from the prior Policy A is low (i.e., there is high similarity), and a relatively small amount of log traffic (i.e., about 1%) is being routed to the new Policy B, then use of counterfactual estimation has advantages over A-B testing (see “CF Wins”). Namely, since variance is a function of model divergence with counterfactual estimation, then a high similarity in the policies maximizes the insight that can be gleaned from the prior Policy A. However, under those same conditions, with a relatively small amount of log traffic being routed to the new Policy B, A-B testing will have few data points to use for estimating the reward of the new policy. The result is a higher variance, lower confidence with A-B testing. In that case, counterfactual estimation is the clear winner for providing a high-quality estimate. Namely, counterfactual estimation performs better when minimal log traffic is routed to the new policy being evaluated, and the policies are similar (i.e., low divergence).

Advantageously, the present techniques leverage the benefits of both approaches to achieve the best of both worlds by combining reward estimates from both off-policy and on-policy estimators. As highlighted above, with on-policy approaches, a user query is answered by the same policy being estimated (e.g., when a subset of log traffic is routed to the new policy being evaluated such as with A-B testing) and, with off-policy approaches, a different policy provides the response shown to the user (e.g., when the new, not-yet deployed policy is being compared to a prior policy such as with counterfactual estimation). Notably, it has been found herein that such a combined estimate outperforms either (off-policy or on-policy) technique alone in all scenarios. In other words, the present techniques leverage both off-policy and on-policy methods simultaneously (referred to herein as a ‘hybrid’ off-policy/on-policy technique) to produce a reward estimate with lower variance than either method alone (i.e., a higher quality reward estimate), thus allowing for more effective safe deployment of new policies.

An overview of the present techniques is provided in FIG. 2. As shown in FIG. 2, estimates of the reward are computed using multiple estimators, i.e., Estimators 1, 2, ... , N. According to an exemplary embodiment, at least a first estimator (Estimator 1) and a second estimator (Estimator 2) are employed. By way of example only, Estimator 1 might be an on-policy method such as A-B testing, and Estimator 2 might be an off-policy method such as counterfactual estimation, i.e., a hybrid on-policy/off-policy approach. In the present example, Estimator 1 produces an Estimate 1, Estimator 2 produces an Estimate 2, and so on. Each Estimate 1, 2, ... , N has some amount of variance depending on the particular scenario. For instance, by way of example only, as provided above A-B testing performs well (has low variance) with high divergence but when the amount of log traffic going to each policy is roughly equal, whereas counterfactual estimation performs well (has low variance) with minimal log traffic being routed to the new policy being evaluated, but when there is low divergence.

Estimates 1, 2, ... , N from Estimators 1, 2, ... , N, respectively, are then provided to a Combiner that is used to combine the multiple Estimates 1, 2, ... , N to produce a high-quality reward estimate. For instance, the Combiner can simply select the estimate (e.g., either Estimate 1 from Estimator 1, Estimate 2 from Estimator 2, etc.) that has the lower variance. However, according to an exemplary embodiment, the Combiner leverages prediction intervals (also referred to herein as probability intervals, confidence intervals, error bars, etc.) to combine estimates (e.g., Estimates 1, 2, ... , N) from multiple estimators (e.g., Estimators 1, 2, ... , N) to produce an improved, higher-quality new reward estimate. This technique allows for combining any number of estimates (with prediction intervals) to produce one higher quality estimate for the new policy’s reward. Advantageously, it has been found herein, that the new reward estimate produced by Combiner has a lower variance (i.e., a higher quality reward estimate) than any of Estimates 1, 2, . . . , N alone.

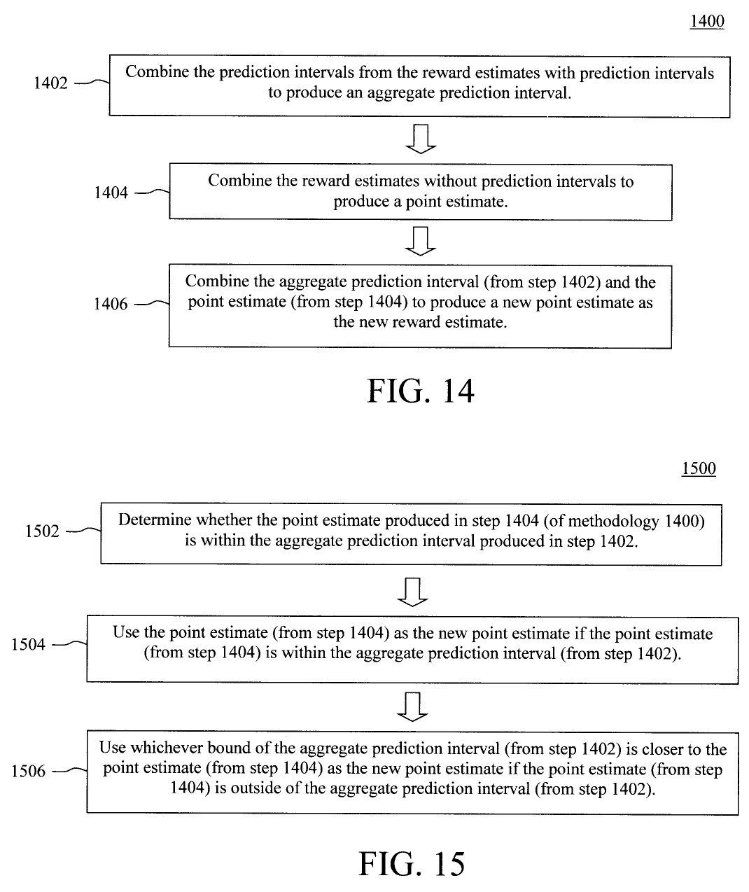

In one exemplary embodiment, each of the estimates (e.g., Estimates 1, 2, ... , N) provided to the Combiner includes a prediction interval with the estimate. The Combiner is then used to combine the multiple estimates with prediction intervals to produce the new reward estimate. However, the present techniques are also applicable to situations where only a subset of the estimations has a prediction interval, meaning that the estimate from at least one of the estimators does not include a prediction interval with the estimate. In that case, the Combiner is used to combine the multiple estimates (and prediction intervals when available) to produce a new singular estimate. This alternative exemplary embodiment is described in detail in conjunction with the description of FIG. 14, below.

As provided above, a policy is an algorithm or system that interacts with an environment by choosing different actions. For instance, in accordance with the present techniques, the policy can be an algorithm that leverages a combination of machine-learning techniques, rule-based techniques, statistical techniques (such as sampling) and/or probabilistic techniques. To use an illustrative, non-limiting example, the policy can consist of an algorithm to provide a response from a pre-constructed set of options as an answer to a query input by the user into the system. This policy can be probabilistic in nature, so that if the same query is submitted multiple times, different responses will be shown according to some frequencies. These frequencies are known, and can be used as an input to the present techniques for estimating the performance of the various policies.

The policy can also be an artificial intelligence (AI) model. Generally, the present techniques are broadly applicable to any type of AI model-based policies including, but not limited to, AI models using a reinforcement learning or contextual bandit framework. By way of example only, an AI model can be embodied in a neural network. In machine learning and cognitive science, neural networks are a family of statistical learning models inspired by the biological neural networks of animals, and in particular the brain. Neural networks may be used to estimate or approximate systems and cognitive functions that depend on a large number of inputs and weights of the connections which are generally unknown.

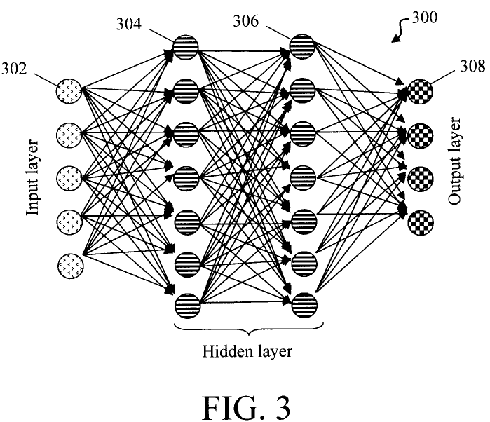

Neural networks are often embodied as so-called “neuromorphic” systems of interconnected processor elements that act as simulated “neurons” that exchange “messages” between each other in the form of electronic signals. See, for example, FIG. 3 which provides a schematic illustration of an exemplary neural network 300. As shown in FIG. 3, neural network 300 includes a plurality of interconnected processor elements 302, 304/306 and 308 that form an input layer, at least one hidden layer, and an output layer, respectively, of the neural network 300. By way of example only, neural network 300 can be embodied in an analog cross-point array of resistive devices such as resistive processing units (RPUs).

Similar to the so-called ‘plasticity’ of synaptic neurotransmitter connections that carry messages between biological neurons, the connections in a neural network that carry electronic messages between simulated neurons are provided with numeric weights that correspond to the strength or weakness of a given connection. The weights can be adjusted and tuned based on experience, making neural networks adaptive to inputs and capable of learning. For example, a control policy neural network is defined by a set of input neurons (see, e.g., input layer 302 in neural network 300). After being weighted and transformed by a function determined by the network’s designer, activations of these input neurons are passed to other downstream neurons, which are often referred to as ‘hidden’ neurons (see, e.g., hidden layers 304 and 306 in neural network 300). This process is repeated until an output neuron is activated (see, e.g., output layer 308 in neural network 300). The activated output neuron makes a class decision. Instead of utilizing the traditional digital model of manipulating zeros and ones, neural networks such as neural network 300 create connections between processing elements that are substantially the functional equivalent of the core system functionality that is being estimated or approximated.

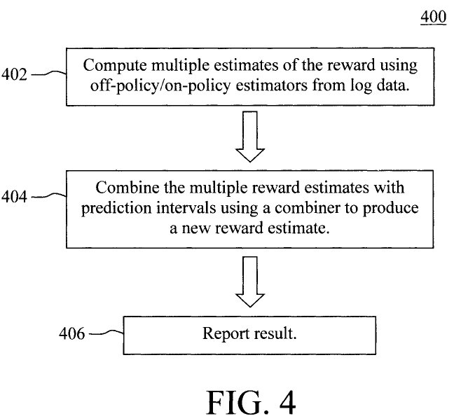

Given the above overview, an exemplary methodology 400 for estimating a reward of a policy P from log data is now described by way of reference to FIG. 4. Log data is a recording of the actions and rewards of one policy, or one set of policies. For instance, by way of example only, with a chatbot application (see above) the log data can provide a record of the responses to user messages chosen by the policy or set of policies (actions) and whether the users liked the responses (rewards). As described above, the policy P can be an algorithm that leverages a combination of machine-learning techniques, rule-based techniques, statistical techniques (such as sampling) and/or probabilistic techniques. The policy P can also be an AI model such as an AI model using a reinforcement learning or contextual bandit framework.

In step 402, multiple estimates of the reward of policy P (i.e., at least two estimates) are computed at the same time using different estimators (see, e.g., Estimates 1, 2, ... , N computed by Estimators 1, 2, ... , N in FIG. 2). According to an exemplary embodiment, at least one of the reward estimates is computed using an off-policy estimator and at least another one of the reward estimates is computed using an on-policy estimator (i.e., a hybrid on-policy/off-policy technique). As described above, suitable off-policy estimators include, but are not limited to, counterfactual estimation, and suitable on-policy estimators include, but are not limited to, A-B testing. Each of these estimators includes a prediction interval (also referred to herein as probability intervals, confidence intervals, error bars, etc.) with their reward estimates, which is used by the combiner to output a new reward estimation. However, as highlighted above, scenarios are also contemplated herein where at least one of the estimators does not include a prediction interval with its estimate. By way of example only, suitable estimators for use in accordance with the present techniques that do not include a prediction interval with their estimates include, but are not limited to, direct methods which employ a model as an estimator such as Doubly Robust, SWITCH and CAB.

A scenario where only a subset of the estimators includes a prediction interval with the estimates is described in conjunction with the description of FIG. 14, below. Thus, in the present example, the exemplary embodiment is being considered where each of the estimators includes a prediction interval with the estimates they compute in step 402. However, it is noted that the present techniques are more generally applicable to any scenario where at least a subset of the estimators include a prediction interval with their estimates, including the case where every estimate has a prediction interval and/or the case where only a subset of the estimators include a prediction interval with their estimates.

In step 404, the combiner (see, e.g., the Combiner in FIG. 2) is then used to combine the multiple estimates from step 402. The estimates from step 402 are computed by the estimators at the same time, and thus under the same conditions (i.e., the same amount of divergence, using the same amount of log data/traffic, etc. - see above). Thus, depending on the situation, the estimates computed by the estimators will differ in their variance. For instance, higher divergence/higher log traffic favors A-B testing to produce an estimate with low variance as compared to counterfactual estimation, while lower divergence/lower log traffic favors counterfactual estimation to produce an estimate with low variance as compared to A-B testing.

As highlighted above, the combiner can simply select the estimate from step 402 that has the lower variance. For instance, to use a simple illustrative non-limiting example, in step 404 the combiner can select the estimate from either counterfactual estimation or A-B testing that has the lowest variance under the given conditions. However, in step 404 it may be preferable to also leverage the prediction intervals included with at least a subset of the estimations in order to produce an improved, higher-quality new reward estimate that will have a lower variance (i.e., provides a higher quality reward estimate) than any of the estimates from any of the estimators alone. Suitable techniques for combining the estimates with prediction intervals to produce a new reward estimate are described below.

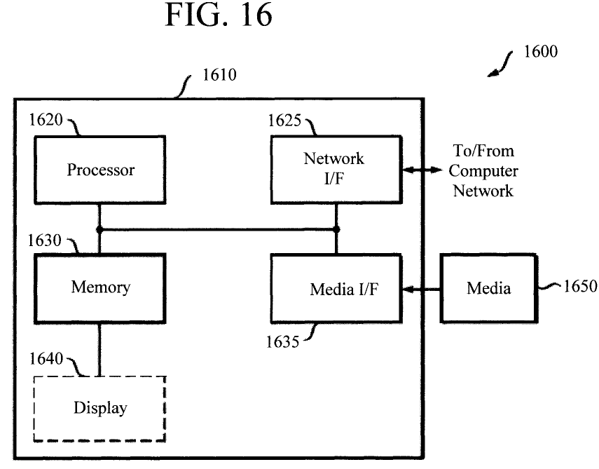

Finally, in step 406 the system reports the result such as the new reward estimate to the user. An exemplary apparatus for performing one or more steps of methodology 400 is described in conjunction with the description of FIG. 16, below.

As highlighted above, the present Combiner takes two or more estimates with prediction intervals such as error bars (an error bar has an upper bound and a lower bound) and outputs a new estimate (reward). A description is now provided of suitable processes that can be implemented by the Combiner in accordance with the present techniques to compute the new reward estimate. However, it is to be understood that the present techniques should not be construed as being limited to any one (or more) of the processes being described.

According to an exemplary embodiment, the multiple reward estimates from step 402 are combined in step 404 using statistical techniques to produce the new reward estimate. For instance, by way of example only, probability distributions imputed from the prediction intervals can be combined by taking the average and using it as the new reward estimate. Namely, if it is assumed that the reward being estimated is a random variable distributed according to a particular probability distribution (i.e., a normal distribution), and that the confidence interval from the estimator corresponds to a known confidence interval (e.g., a 90% or 95% confidence interval), then the parameters of those distributions (mean and standard deviation for a normal distribution) can be aggregated to get both a mean and confidence interval for the combined estimate using techniques well-known in the art for obtaining a sum of normally distributed random variables.

According to another exemplary embodiment, the multiple reward estimates from step 402 are combined in step 404 using a heuristic technique. For instance, one option (as described above) is for the combiner to simply select the estimate from step 402 that has the lowest variance, namely the estimate with the smallest prediction interval.

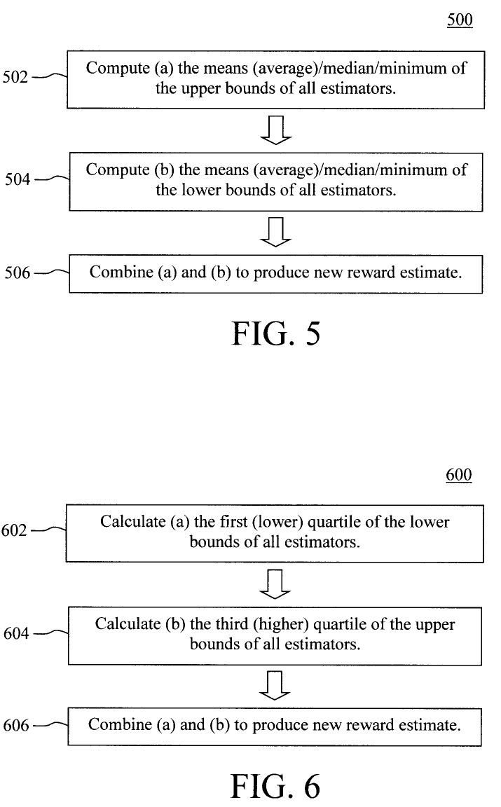

Another option is to aggregate the estimates based on the mean (average), median and/or minimum/maximum upper and lower bounds of the estimates. See, for example, methodology 500 of FIG. 5. For instance, with averaging, in step 502 the combiner computes (a) the means (i.e., average) of the upper bounds of all of the estimates with prediction intervals. In step 504, the combiner computes (b) the means (i.e., average) of the lower bounds of all of the estimates with prediction intervals. In step 506, the means computed of the (a) upper and (b) lower bounds in steps 502 and 504, respectively, are combined using a statistical technique such as average, weighted average, fitting quantiles of a probability distribution, etc. to produce the new reward estimate. For instance, by way of example only, the combiner can combine (a) and (b) in step 506 by taking the average and using it as the new reward estimate.

In a similar manner, the combiner can compute (a) the median of the upper bounds of all of the estimates with prediction intervals (step 502) and (b) the median of the lower bounds of all of the estimates with prediction intervals (step 504), and then combine (a) and (b) using a statistical technique such as average, weighted average, fitting quantiles of a probability distribution, etc. to produce the new reward estimate (step 506). For instance, by way of example only, the combiner can combine (a) and (b) in step 506 by taking the average and using it as the new reward estimate.

Enveloping can also be employed whereby the combiner computes (a) the minimum of the upper bounds of all of the estimates with prediction intervals (step 502) and (b) the maximum of the lower bounds of all of the estimates with prediction intervals (step 504), and then combines (a) and (b) using a statistical technique such as average, weighted average, fitting quantiles of a probability distribution, etc. to produce the new reward estimate (step 506). For instance, by way of example only, the combiner can combine (a) and (b) in step 506 by taking the average and using it as the new reward estimate.

Yet another option is to aggregate the estimates using quartiles. See, for example, methodology 600 of FIG. 6. In statistics, a quartile divides the number of data points into four parts or quarters, whereby the first quartile is the middle value between the smallest number (minimum) and the median of the data points, the second quartile is the median of the data points, and the third quartile is the middle value between the median and the highest value (maximum) of the data points. For instance, in step 602 the combiner calculates (a) the first (lower) quartile of the lower bounds of all of the estimates with prediction intervals. In step 604, the combiner computes (b) the third (higher) quartile of the upper bounds of all of the estimates with prediction intervals. In step 606, the (a) first (lower) quartile and the (b) third (higher) quartile calculated in steps 602 and 604, respectively, are combined using a statistical technique such as average, weighted average, fitting quantiles of a probability distribution, etc. to produce the new reward estimate. For instance, by way of example only, the combiner can combine (a) and (b) in step 606 by taking the average and using it as the new reward estimate.

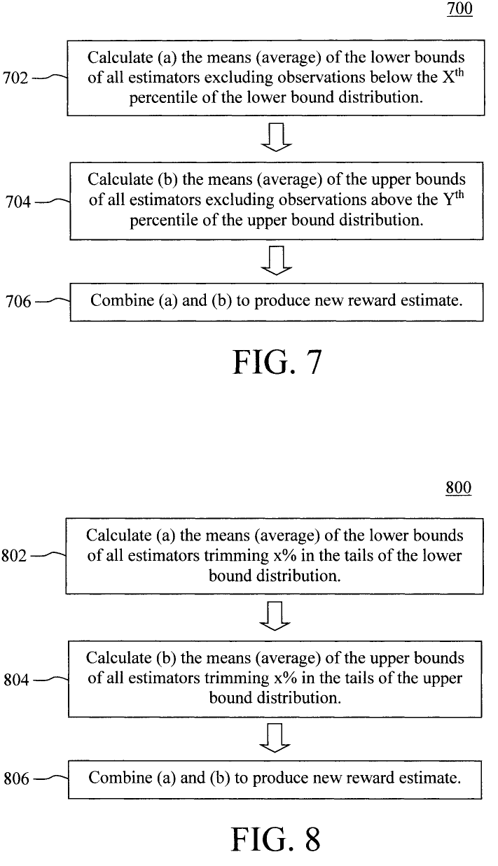

Variations of the above-described heuristic techniques are also contemplated herein, such as trimmed mean approaches. Basically, with a trimmed mean (also referred to herein as a ‘truncated mean’), a predetermined number of values is removed at the high and the low ends of a distribution, and an average of the remaining values is taken. For instance, still yet another option is to aggregate the estimates using an asymmetric trimmed mean approach. See, for example, methodology 700 of FIG. 7. Namely, in step 702 the combiner calculates (a) the means (i.e., average) of the lower bounds of all of the estimates with prediction intervals excluding observations below the X^{th} percentile of the lower bound distribution. In step 704, the combiner calculates (b) the means (i.e., average) of the upper bounds of all of the estimates with prediction intervals excluding observations above the Y^{th} percentile of the upper bound distribution. In step 706, the trimmed means calculated of the (a) lower and (b) upper bounds in steps 702 and 704, respectively, are combined using a statistical technique such as average, weighted average, fitting quantiles of a probability distribution, etc. to produce the new reward estimate. For instance, by way of example only, the combiner can combine (a) and (b) in step 706 by taking the average and using it as the new reward estimate. For illustrative purposes only, in one embodiment, X = 10 and Y = 90. In that case, observations below the 10^{th} percentile of the lower bound distribution and observations above the 90^{th} percentile of the upper bound distribution are excluded. In another embodiment, X = 25 and Y = 75. In that case, observations below the 25^{th} percentile of the lower bound distribution and observations above the 75^{th} percentile of the upper bound distribution are excluded.

A symmetric trimmed mean approach may also be employed. See, for example, methodology 800 of FIG. 8. Namely, in step 802 the combiner calculates (a) the means (i.e., average) of the lower bounds of all of the estimates with prediction intervals trimming x% in the tails of the lower bound distribution. In step 804, the combiner calculates (b) the means (i.e., average) of the upper bounds of all of the estimates with prediction intervals trimming x% in the tails of the upper bound distribution. In step 806, the trimmed means computed of the (a) lower and (b) upper bounds in steps 802 and 804, respectively, are combined using a statistical technique such as average, weighted average, fitting quantiles of a probability distribution, etc. to produce the new reward estimate. For instance, by way of example only, the combiner can combine (a) and (b) in step 806 by taking the average and using it as the new reward estimate. For illustrative purposes only, in one embodiment, x = 10. In that case, 10% in the tails of both the lower and the upper bound distributions are trimmed. In another embodiment, x = 25. In that case, 25% in the tails of both the lower and the upper bound distributions are trimmed.

Other approaches contemplated herein for combining the multiple reward estimates as per step 404 of methodology 400 include, but are not limited to, unweighted average, median judgement, median absolute deviation, precision-weighted average, probability-weighted average, certainty-weighted average and/or entropy-weighted average. With unweighted average for instance, given a set of the reward estimates {eᵢ} (from step 402 of methodology 400), the average value avg({eᵢ}) is used as the new reward estimate. Similarly, with median judgement, given the set of the reward estimates {eᵢ} (from step 402 of methodology 400), the median value median ({e, }) is used as the new reward estimate.

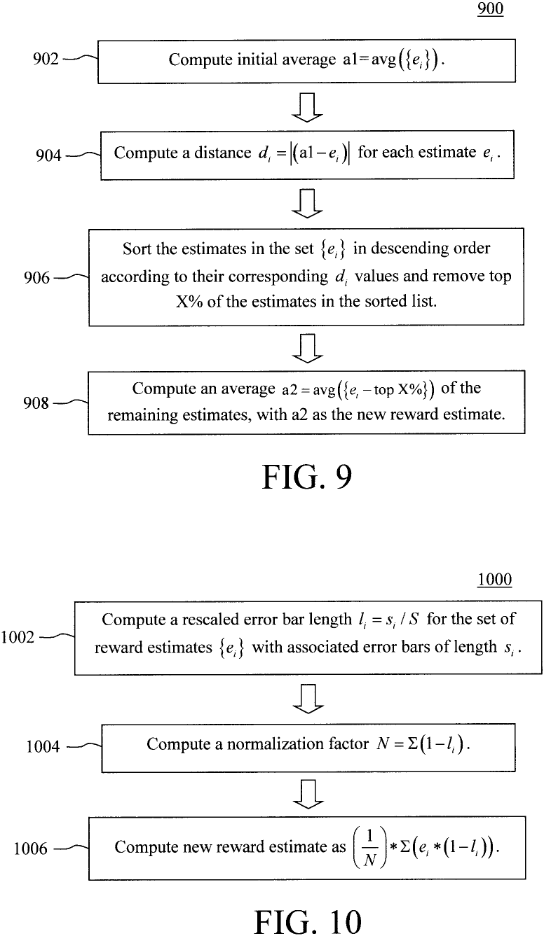

With a median absolute deviation approach, referring to methodology 900 of FIG. 9, an initial average a1 is computed is for the set {eᵢ} of the reward estimates with prediction intervals, i.e., a1 = avg ({eᵢ}) (see step 902). The initial average a1 is then used to compute a distance dᵢ = |(a1 - eᵢ)| for each estimate eᵢ in set {eᵢ} (see step 904). The estimates in the set {eᵢ} are sorted in descending order according to their corresponding dᵢ values to produce a sorted list. The top X% (e.g., X% is from about 5% to about 10%) of the estimates in the sorted list are removed (see step 906). In step 908, an average a2 of the estimates that remain in set {eᵢ} is then computed as:

$$\text{a2=avg} \left(\left\{{e}_{i} - \text{top X\%}\right\}\right) ,$$

wherein a2 is used as the new reward estimate.

With a precision-weighted average approach, referring to methodology 1000 of FIG. 10, given the set {eᵢ} of the reward estimates with prediction intervals and associated error bars of length sᵢ, for each estimate eᵢ in set {eᵢ} a rescaled error bar length lᵢ = sᵢ / S is computed (see step 1002), wherein S is the largest error bar in set {eᵢ . In step 1004, the rescaled error bar length lᵢ is then used to compute a normalization factor N = Σ(1 - lᵢ ). With the normalization factor N , the new reward estimate is computed in step 1006 as:

$$\left(\frac{1}{N}\right) ∗ \sum \left(e , ∗ \left(1 - {l}_{i}\right)\right) .$$

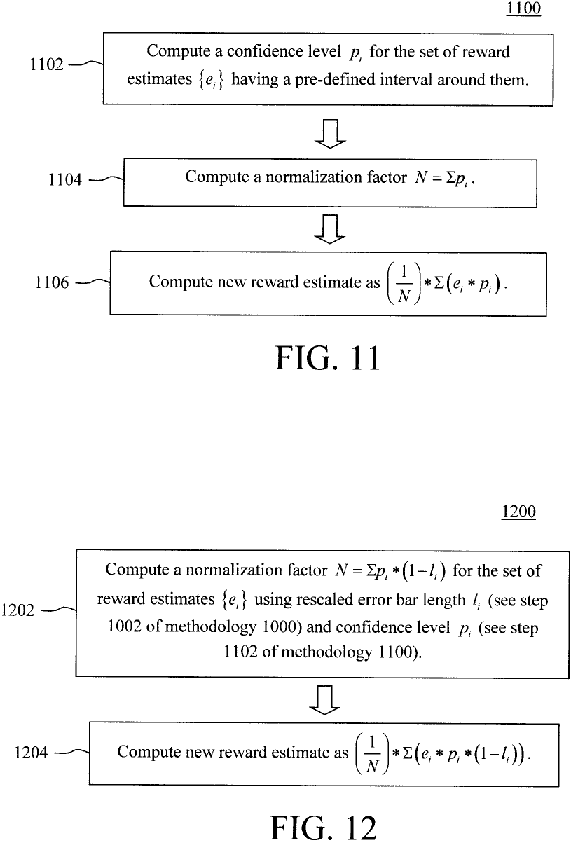

With a probability-weighted average approach, referring to methodology 1100 of FIG. 11, given the set {eᵢ} of the reward estimates with prediction intervals and a pre-defined interval around them (for example eᵢ ± 1%), a confidence level pᵢ is computed which corresponds to a confidence interval of this fixed size (i.e., the pre-defined interval) (using for example a normal distribution or bootstrapping) (see step 1102). It is assumed that an error bar of fixed, pre-defined width is calculated and centered on the estimate. For instance, if the estimate from one estimator is 70%, and the width of the interval is chosen to be 1%, then the estimate with confidence interval would be 70 ± 1%. Depending on the methodology of the estimator, the assumptions that it relies on, and the number of datapoints that it uses, the confidence level associated with an error bar of that size can be determined, i.e., does that estimate have a 90% confidence interval of size ±1%, or is it only 75% confident that the estimate is within ±1%. In step 1104, the confidence level pᵢ is used to compute a normalization factor N = Σpᵢ . With the normalization factor N, the new reward estimate is computed in step 1106 as:

$$\left(\frac{1}{N}\right) ∗ \sum \left({e}_{i} ∗ {p}_{i}\right) .$$

With a certainty-weighted average approach, referring to methodology 1200 of FIG. 12, given the set {eᵢ} of the reward estimates with prediction intervals, and the rescaled error bar length lᵢ (see step 1002 of methodology 1000) and confidence level pᵢ (see step 1102 of methodology 1100) as defined above, a normalization factor N = Σp₁ ^{∗}(1-lᵢ) is computed (see step 1202). With the normalization factor N, the new reward estimate is computed in step 1204 as:

$$\left(\frac{1}{N}\right) ∗ \sum \left({e}_{i} ∗ {p}_{i} ∗ \left(1 - {l}_{i}\right)\right) .$$

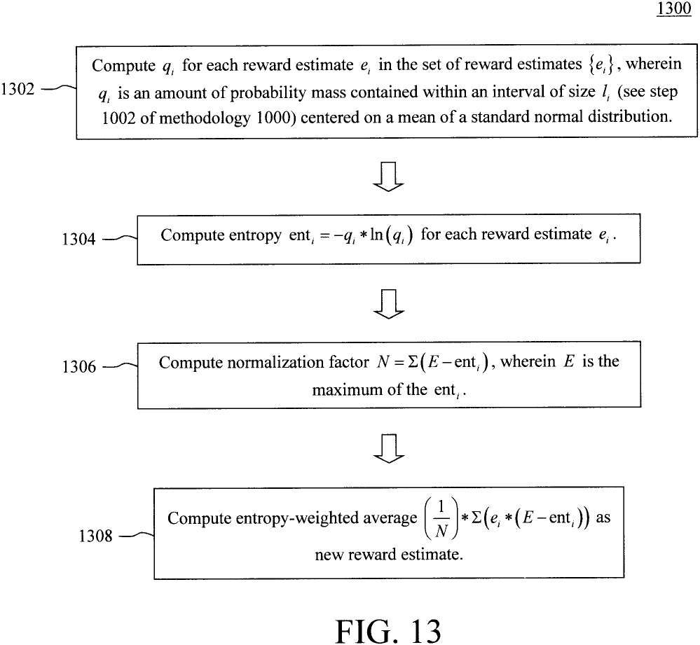

With an entropy-weighted average approach, referring to methodology 1300 of FIG. 13, given the set {eᵢ} of the reward estimates with prediction intervals, and the rescaled error bar length lᵢ (see step 1002 of methodology 1000) as defined above, qᵢ is computed for each estimate eᵢ in the set {eᵢ}, wherein qᵢ is an amount of probability mass contained within an interval of size lᵢ centered on a mean of a standard normal distribution (see step 1302). With qᵢ , entropy entᵢ = -qᵢ ^{∗} 1n (qᵢ) is computed in step 1304 for each estimate eᵢ in the set {eᵢ}, wherein 1n is the natural logarithm. With the entropy entᵢ, in step 1306 a normalization factor N = Σ(E - entᵢ ) is computed, wherein E is the maximum of the entᵢ. In step 1308, an entropy-weighted average is computed as:

$$\left(\frac{1}{N}\right) ∗ \sum \left({e}_{i} ∗ \left(E - {\text{ent}}_{i}\right)\right) ,$$

and this entropy-weighted average is used as the new reward estimate.

As provided above, scenarios are also contemplated herein where only a subset of the estimators includes a prediction interval (e.g., error bars) with their reward estimates, meaning that the reward estimate(s) from at least one of the other estimators does not include a prediction interval with its reward estimate. By way of example only, off-policy estimators such as counterfactual estimation and on-policy estimators such as A-B testing include a prediction interval with their estimates, whereas direct methods which employ a model as an estimator such as Doubly Robust, SWITCH and CAB (see above) do not include a prediction interval with their estimates.

Thus, when combining reward estimates (with and without prediction intervals) from amongst these different types of estimators, a slightly different approach is employed whereby the estimates (and prediction intervals when available) are combined in a manner so as to produce a new (singular) reward estimate. See, for example, exemplary methodology 1400 of FIG. 14. According to an exemplary embodiment, the steps of methodology 1400 are performed by the present Combiner described, for example, in conjunction with the description of FIG. 2, above. Referring briefly to FIG. 2, in this exemplary scenario, a subset of the Estimates 1, 2, ... , N include prediction intervals, while one or more other of the Estimates 1, 2, ... , N are provided without prediction intervals.

Namely, referring back to methodology 1400, in step 1402 the reward estimates and prediction intervals from the estimates with prediction intervals are combined to produce an aggregate prediction interval. The fundamental problem addressed here is estimating the value of the reward from a policy, which is a single number (such as the percentage of users who like a response chosen by the control policy in a chatbot application (so then in the range 0-100)). Some estimators will produce a reward estimate, e.g., 60%, along with a prediction interval, or a range/error bar, e.g., ±5%, making the overall prediction 60% ±5% or (55% - 65%). However, not all estimators have a natural way of generating an error bar along with their estimate. For these estimators, it might be known that the likeliest value is 60%, but there is no information about how far off from reality that estimate might be.

In order to combine multiple estimates into a single estimate, one could produce only an overall combined value for the single-number estimate. For instance, to use an illustrative, non-limiting example, given estimates of 60% ± 5%, 50% ± 10%, and 65% ±15%, the combined estimate might be 58%. However, the present techniques not only use the individual prediction intervals/error bars to help produce the combined estimate for the single-number reward estimate (as in the preceding example), but also for a combined prediction interval around it. For instance, to use an illustrative, non-limiting example, given estimates of 60% ± 5%, 50% ± 10% , and 65% ±15%, a combined estimate with prediction interval might be 58% ± 9%.

In step 1404, the reward estimates without prediction intervals are combined to produce a point estimate. In general, point estimation involves calculating a single value, i.e., a point estimate, from data that serves as an estimate of a population parameter such as mean, median, etc. Suitable techniques for combining the reward estimates without prediction intervals to produce the new point estimate include, but are not limited to, statistical techniques such as average, median, etc.

In step 1406, the aggregate prediction interval (from step 1402) and the point estimate (from step 1404) are combined to produce a new point estimate as the new reward estimate. This combining can be performed using various heuristic and statistical techniques. By way of example only, a suitable heuristic technique is now described by way of reference to exemplary methodology 1500 in FIG. 15.

Referring to methodology 1500, in step 1502 a determination is made as to whether the point estimate produced in step 1404 (of methodology 1400 in FIG. 14) is within the aggregate prediction interval produced in step 1402. Namely, the point estimate is a single value and the aggregate prediction interval is a range. Thus, it is determined in step 1502 whether the value of the point estimate is within the aggregate prediction interval range. If the point estimate (from step 1404) is within the aggregate prediction interval (from step 1402), then in step 1504 the point estimate (from step 1404) is used as the new point estimate. Otherwise, if the point estimate (from step 1404) is outside of the aggregate prediction interval (from step 1402), then in step 1506 whichever bound of the aggregate prediction interval (from step 1402) (i.e., upper confidence bound or lower confidence bound) is closer to the point estimate (from step 1404) is used as the new point estimate. To use an illustrative, non-limiting example, if the point estimate is 80% and the aggregate prediction interval is 50% - 60%, then the point estimate is not within the range of the aggregate prediction interval, and in step 1506 the closer bound of the aggregate prediction interval is taken as the new point estimate, which in the instant example would be 60%.

The present techniques are further described by way of reference to the following non-limiting example. In this example, a historical log of chatbot interactions was provided, including samples from two different policies, policy P1 and policy P2 (i.e., some of the samples have responses generated using policy P1 as the control policy, and some samples have responses generated using P2 as the control policy), and the goal was to estimate the click rate that would have been obtained from these interactions had policy P1 been used to generate all of the responses.

The two estimators used were A-B testing and inverse propensity scoring (IPS). The combiner used a precision-weighted average approach to combine the reward estimates from the estimators. Namely, the weighted average of the estimates from the two estimators was taken using (1 - confidence _interval _width) as the weight, wherein confidence interval _width is the width of a pre-specified (e.g., 95%) confidence interval for each estimate. The combined estimate is to be more heavily influenced by the single estimate with lower variance.

For the estimate generated using A-B testing (Estimate 1), the average click rate observed on the subset of responses using policy P1 was used. For the estimate generated using counterfactual estimation (Estimate 2), the click rate was estimated by:

$${\sum }_{i ∈ log} \left(\frac{{P}_{i}^{log}}{{P}_{i}^{\left(2\right)}}\right) {C}_{i} ,$$

wherein i indexes the interactions in the log,

$${P}_{i}^{log}$$

is the probability assigned to the response in this interaction by whichever policy was used to choose it,

$${P}_{i}^{\left(2\right)}$$

is the probability assigned to this response by policy P2 (which may be the same as

$$\left({P}_{i}^{log}\right) ,$$

and Cᵢ is 1 if the response received a click and 0 if not.

As will be described below, one or more elements of the present techniques can optionally be provided as a service in a cloud environment. For instance, one or more steps of methodology 400 of FIG. 4, one or more steps of methodology 500 of FIG. 5, one or more steps of methodology 600 of FIG. 6, one or more steps of methodology 700 of FIG. 7, one or more steps of methodology 800 of FIG. 8, one or more steps of methodology 900 of FIG. 9, one or more steps of methodology 1000 of FIG. 10, one or more steps of methodology 1100 of FIG. 11, one or more steps of methodology 1200 of FIG. 12, one or more steps of methodology 1300 of FIG. 13, one or more steps of methodology 1400 of FIG. 14 and/or one or more steps of methodology 1500 of FIG. 15 can be performed on a dedicated cloud server to take advantage of high-powered CPUs and GPUs, after which the result is sent back to a local device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now to FIG. 16, a block diagram is shown of an apparatus 1600 for implementing one or more of the methodologies presented herein. By way of example only, the Estimators 1, 2, ... , N and/or the Combiner (see FIG. 2 above) can be embodied in apparatus 1600, and apparatus 1600 can be configured to implement one or more steps of methodology 400 of FIG. 4, one or more steps of methodology 500 of FIG. 5, one or more steps of methodology 600 of FIG. 6, one or more steps of methodology 700 of FIG. 7, one or more steps of methodology 800 of FIG. 8, one or more steps of methodology 900 of FIG. 9, one or more steps of methodology 1000 of FIG. 10, one or more steps of methodology 1100 of FIG. 11, one or more steps of methodology 1200 of FIG. 12, one or more steps of methodology 1300 of FIG. 13, one or more steps of methodology 1400 of FIG. 14 and/or one or more steps of methodology 1500 of FIG. 15.

Apparatus 1600 includes a computer system 1610 and removable media 1650. Computer system 1610 includes a processor device 1620, a network interface 1625, a memory 1630, a media interface 1635 and an optional display 1640. Network interface 1625 allows computer system 1610 to connect to a network, while media interface 1635 allows computer system 1610 to interact with media, such as a hard drive or removable media 1650.

Processor device 1620 can be configured to implement the methods, steps, and functions disclosed herein. The memory 1630 could be distributed or local and the processor device 1620 could be distributed or singular. The memory 1630 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1620. With this definition, information on a network, accessible through network interface 1625, is still within memory 1630 because the processor device 1620 can retrieve the information from the network. It should be noted that each distributed processor that makes up processor device 1620 generally contains its own addressable memory space. It should also be noted that some or all of computer system 1610 can be incorporated into an application-specific or general-use integrated circuit.

Optional display 1640 is any type of display suitable for interacting with a human user of apparatus 1600. Generally, display 1640 is a computer monitor or other similar display.

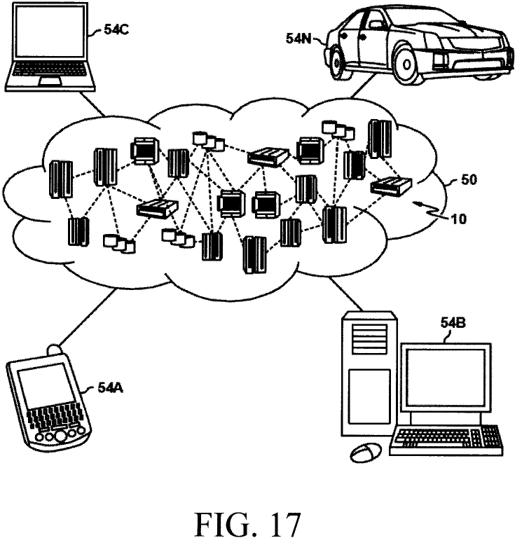

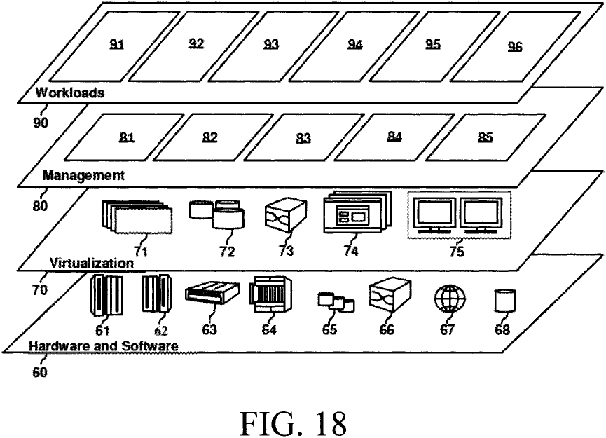

Referring to FIG. 17 and FIG. 18, it is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 17, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 17 are intended to be illustrative only and that computing nodes 10 and cloud computing environment 50 can communicate with any type of computerized device over any type of network and/or network addressable connection (e.g., using a web browser).

Referring now to FIG. 18, a set of functional abstraction layers provided by cloud computing environment 50 (FIG. 17) is shown. It should be understood in advance that the components, layers, and functions shown in FIG. 18 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and estimating a reward of a policy 96.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A computer-based method for estimating a reward of a policy for decision making in a computer system, the method comprising:
computing multiple reward estimates of the policy using estimators, wherein at least a subset of the estimators compute reward estimates with prediction intervals; and
combining the multiple reward estimates using a combiner to produce a new reward estimate.

2. The computer-based method of claim 1, wherein the new reward estimate has a lower variance than any of the multiple reward estimates alone.

3. The computer-based method of claim 1, wherein each of the estimators computes the reward estimates with prediction intervals.

4. The computer-based method of claim 1, wherein one or more of the estimators compute reward estimates without prediction intervals.

5. The computer-based method of claim 1, wherein at least one of the estimators comprises an off-policy estimator, and wherein at least another one of the estimators comprises an on-policy estimator.

6. The computer-based method of claim 5, wherein the off-policy estimator comprises counterfactual estimation, and wherein the on-policy estimator comprises A-B testing.

7. The computer-based method of claim 1, wherein at least one of the estimators comprises a model.

8. The computer-based method of claim 1, wherein combining the multiple reward estimates comprises:
computing (a) at least one of a mean, a median, and a minimum of upper bounds of all of the estimates with prediction intervals;
computing (b) at least one of a mean, a median, and a maximum of lower bounds of all of the estimates with prediction intervals; and
combining (a) and (b) using a statistical technique selected from the group consisting of:
average, weighted average, and fitting quantiles of a probability distribution to produce the new reward estimate.

9. The computer-based method of claim 1, wherein combining the multiple reward estimates comprises:
calculating (a) a first quartile of lower bounds of all of the estimates with prediction intervals;
calculating (b) a third quartile of upper bounds of all of the estimates with prediction intervals; and
combining (a) and (b) using a statistical technique selected from the group consisting of:
average, weighted average, and fitting quantiles of a probability distribution to produce the new reward estimate.

10. The computer-based method of claim 1, wherein combining the multiple reward estimates comprises:
calculating (a) means of lower bounds of all of the estimates with prediction intervals excluding observations below an X^{th} percentile of a lower bound distribution;
calculating (b) means of upper bounds of all of the estimates with prediction intervals excluding observations above an Y^{th} percentile of an upper bound distribution; and
combining (a) and (b) using a statistical technique selected from the group consisting of:
average, weighted average, and fitting quantiles of a probability distribution to produce the new reward estimate.

11. The computer-based method of claim 10, wherein X = 10 and Y = 90, and wherein the observations below a 10^{th} percentile of the lower bound distribution and the observations above a 90^{th} percentile of the upper bound distribution are excluded.

12. The computer-based method of claim 10, wherein X = 25 and Y = 75, and wherein the observations below a 25^{th} percentile of the lower bound distribution and the observations above a 75^{th} percentile of the upper bound distribution are excluded.

13. The computer-based method of claim 1, wherein combining the multiple reward estimates comprises:
calculating (a) means of lower bounds of all of the estimates with prediction intervals trimming x% in tails of a lower bound distribution;
calculating (b) means of upper bounds of all of the estimates with prediction intervals trimming x% in tails of an upper bound distribution; and
combining (a) and (b) using a statistical technique selected from the group consisting of:
average, weighted average, and fitting quantiles of a probability distribution to produce the new reward estimate.

14. The computer-based method of claim 13, wherein x = 10, and wherein 10% in the tails of both the lower bound distribution and the upper bound distribution are trimmed.

15. The computer-based method of claim 13, wherein x = 25, and wherein 25% in the tails of both the lower bound distribution and the upper bound distribution are trimmed.

16. The computer-based method of claim 1, wherein combining the multiple reward estimates comprises:
computing an initial average a1 for a set {eᵢ}of the reward estimates with prediction intervals as: al=avg({eᵢ});
computing a distance dᵢ= |(al -eᵢ)| for each estimate eᵢ in the set {eᵢ};
sorting the reward estimates in descending order according to the distance dᵢ for each estimate eᵢ in the set {eᵢ} to provide a sorted list, and removing top X% of estimates in the sorted list, wherein X% is from about 5% to about 10%; and
computing an average a2 of the estimates that remain in the set {eᵢ} as:
a2 = avg({eᵢ-top X%}), wherein a2 is used as the new reward estimate.

17. The computer-based method of claim 1, wherein combining the multiple reward estimates comprises:
computing a rescaled error bar length lᵢ = sᵢ / S for each estimate eᵢ in a set {eᵢ} of the reward estimates with prediction intervals and associated error bars of length sᵢ, wherein S is a largest error bar in the set {eᵢ};
computing a normalization factor N = Σ(1 - lᵢ ) ; and
computing the new reward estimate as:
$$\left(\frac{1}{N}\right) ∗ \sum \left({e}_{i} ∗ \left(1 - {l}_{i}\right)\right) .$$
.

18. The computer-based method of claim 1, wherein combining the multiple reward estimates comprises:
computing a confidence level pᵢ corresponding to a pre-defined interval around a set {eᵢ} of the reward estimates with prediction intervals;
computing a normalization factor N = Σpᵢ; and
computing the new reward estimate as:
$$\left(\frac{1}{N}\right) ∗ \sum \left({e}_{i} ∗ {p}_{i}\right) .$$
.

19. The computer-based method of claim 1, wherein combining the multiple reward estimates comprises:
computing a rescaled error bar length lᵢ = sᵢ / S for each estimate eᵢ in a set {eᵢ} of the reward estimates with prediction intervals and associated error bars of length sᵢ, wherein S is a largest error bar in the set {eᵢ};
computing a confidence level pᵢ corresponding to a pre-defined interval around a set {eᵢ} of the reward estimates with prediction intervals;
computing a normalization factor N = Σpᵢ^{∗}(1-lᵢ); and
computing the new reward estimate as:
$$\left(\frac{1}{N}\right) ∗ \sum \left({e}_{i} ∗ {p}_{i} ∗ \left(1 - {l}_{i}\right)\right) .$$
.

20. The computer-based method of claim 1, wherein combining the multiple reward estimates comprises:
computing a rescaled error bar length lᵢ = sᵢ / S for each estimate eᵢ in a set {eᵢ} of the reward estimates with prediction intervals and associated error bars of length sᵢ, wherein S is a largest error bar in the set {eᵢ};
computing qᵢ for each estimate eᵢ in the set {e_{i}}, wherein qᵢ is an amount of probability mass contained within an interval of size lᵢ centered on a mean of a standard normal distribution;
computing entropy entᵢ = -qᵢ∗ ln(qᵢ) for each estimate eᵢ in the set {e,};
computing a normalization factor N = Σ(E-entᵢ), wherein E is a maximum of entᵢ; and
computing an entropy-weighted average as:
$$\left(\frac{1}{N}\right) ∗ \sum \left({e}_{i} ∗ \left(E - e n {t}_{i}\right)\right) ,$$
wherein the entropy-weighted average is used as the new reward estimate.

21. A computer-based method for estimating a reward of a policy for decision making in a computer system, the method comprising:
computing multiple reward estimates of the policy using estimators, wherein a subset of the estimators compute reward estimates with prediction intervals, and another one or more of the estimators compute reward estimates without prediction intervals; and
combining the reward estimates with prediction intervals and the reward estimates without prediction intervals using a combiner to produce a new reward estimate.

22. The computer-based method of claim 21, further comprising:
combining the reward estimates with prediction intervals to produce an aggregate prediction interval;
combining the reward estimates without prediction intervals to produce a point estimate; and
combining the aggregate prediction interval and the point estimate to produce a new point estimate, wherein the new point estimate is used as the new reward estimate.

23. The computer-based method of claim 22, further comprising:
determining whether the point estimate is within the aggregate prediction interval;
using the point estimate as the new point estimate if the point estimate is within the aggregate prediction interval; and
using whichever of an upper confidence bound or a lower confidence bound is closer to the point estimate as the new point estimate.

24. A non-transitory computer program product for estimating a reward of a policy for decision making in a computer system, the computer program product comprising a computer readable storage medium having program instructions embodied therewith, the program instructions executable by a computer to cause the computer to:
compute multiple reward estimates of the policy using estimators, wherein at least a subset of the estimators compute reward estimates with prediction intervals; and
combine the multiple reward estimates using a combiner to produce a new reward estimate, wherein the new reward estimate has a lower variance than any of the multiple reward estimates alone.

25. A non-transitory computer program product for estimating a reward of a policy for decision making in a computer system, the computer program product comprising a computer readable storage medium having program instructions embodied therewith, the program instructions executable by a computer to cause the computer to:
compute multiple reward estimates of the policy using estimators, wherein a subset of the estimators compute reward estimates with prediction intervals, and another one or more of the estimators compute reward estimates without prediction intervals;
combine the reward estimates with prediction intervals to produce an aggregate prediction interval;
combine the reward estimates without prediction intervals to produce a point estimate; and
combine the aggregate prediction interval and the point estimate to produce a new point estimate, wherein the new point estimate is used as the new reward estimate.
